(19) United States
(12) Patent Application Publication
(10) Pub. No.: US 2016/0127037 A1
(43) Pub. Date: May 5, 2016

(54) Method And Apparatus For Determining Transmission Quality

(71) Applicant: TELEFONAKTIEBOLAGET L M ERICSSON (PUBL), Stockholm (SE)

(72) Inventors: Fabio Cavaliere, Pisa (IT); Stefano Chinnici, Pisa (IT)

(21) Appl. No.: 14/893,057

(22) PCT Filed: May 23, 2013
(86) PCT No.: PCT/EP2013/060654

§ 371 Date: Nov. 21, 2015

(51) Int. Cl. H04B 10/079

(52) U.S. Cl. CPC H04B 10/07953

(57) ABSTRACT

A method of determining a transmission quality of a transmission. The method comprises detecting and/or decoding the transmission using an iterative operation, and generating a value of one or more iteration parameter of the iterative operation. The method further comprises calculating the transmission quality based on the value of the one or more iteration parameter.

### TECHNICAL FIELD

Aspects of the invention relate to a method of determining a transmission quality, for example a signal-to-noise ratio (SNR) or system margin, and to an apparatus configured to determine a transmission quality of a transmission.

### BACKGROUND

Recent powerful coding techniques, e.g. a turbo code or a low density parity check (LDPC) code, are used for error correction. These codes are examples of forward error correction (FEC) codes. FIG. 1 shows an example of the dependence of post-decoding bit error rate (BER) on optical signal-to-noise ratio (OSNR). The graph shows four different code rates of LDPC code 101,102,103,104. Lines 101,102,103,104 respectively show a progressively increasing code rate. The code rate is defined as the ratio between payload and the total number of bits in the transmission.

Line 101 has the lowest of the illustrated code rates, having a code rate of 3/4. Line 102 has a code rate of 5/6, line 103 has a code rate of 8/9, and line 104 has the highest shown code rate of 9/10. Using a higher code rate is advantageous, if possible, due to the higher net spectral efficiency, i.e. more transmitted payload bits at a given bit rate.

The BER curves are relatively steep, particularly those of the higher code rates, e.g. lines 103,104. The applicant has realised that a simple measurement of post-decoding BER may not provide an accurate determination of the SNR, particularly at high code rates.

A determination of SNR may be used to determine a system margin. The system margin is defined as the difference between actual SNR and a threshold SNR. The system margin corresponds to the operating proximity of the installed system from the threshold SNR, beyond which the transmission may not be reliably received. The threshold SNR is pre-determined for a particular system, including the FEC used. Therefore, determining the current system margin from post-decoding BER is difficult in some circumstances, potentially leading to an abrupt out-of-service condition.

### SUMMARY

A first aspect of the present invention provides a method of determining a transmission quality of a transmission. The method comprising detecting and/or decoding the transmission using an iterative operation, and generating a value of one or more iteration parameter of the iterative operation. The method further comprises calculating the transmission quality based on the value of the one or more iteration parameter.

Thus, the method allows accurate determination of transmission quality.

Optionally, the method comprises detecting and decoding the transmission using an iterative operation between the detecting and decoding.

Optionally, the method comprises iteratively decoding the transmission.

Optionally, the iteration parameter is a count of iterations of the iterative operation.

A second aspect of the present invention provides a determining apparatus configured to determine a transmission quality of a transmission. The determining apparatus is configured to receive information from a receiver comprising a detector and a decoder, wherein at least one of the detector and decoder are configured to use an iterative operation. The determining apparatus comprises: a measurement unit configured to measure a value of one or more iteration parameter of the iterative operation, and a calculation unit configured to calculate the transmission quality based on the value of the one or more iteration parameter.

Optionally, the iteration parameter is a count of iterations in the iterative operation.

### BRIEF DESCRIPTION OF THE DRAWINGS

Embodiments of the present invention will now be described, by way of example only, with reference to the accompanying drawings in which:

FIG. 1 is a prior art graph illustrating the relationship between BER and SNR for various code rates;

FIG. 2 is a schematic view of a receiver and an embodiment of the present invention;

FIG. 3a is a schematic view of a decoder and an embodiment of the present invention for a parallel turbo code;

FIG. 3b is a schematic view of a decoder and an embodiment of the present invention for a serial turbo code;

FIG. 4 is a graph showing the relationship between BER and an iteration parameter for a turbo code;

FIG. 5 shows a prior art diagram for illustrating the functioning of a LDPC decoder;

FIG. 6 is a schematic view of a decoder and an embodiment of aspect of the present invention for a LDPC code;

FIG. 7a is a graph showing the relationship between BER and an iteration parameter for a LDPC code;

FIG. 7b is a graph showing the relationship between a further iteration parameter for a LDPC code and number of decoding iterations;

FIG. 8 is a schematic view of a receiver and an embodiment of a further aspect of the present invention;

FIG. 9 is a flowchart illustrating a method according to an aspect of the present invention; and

FIG. 10 is a flowchart illustrating a method according to a further aspect of the present invention.

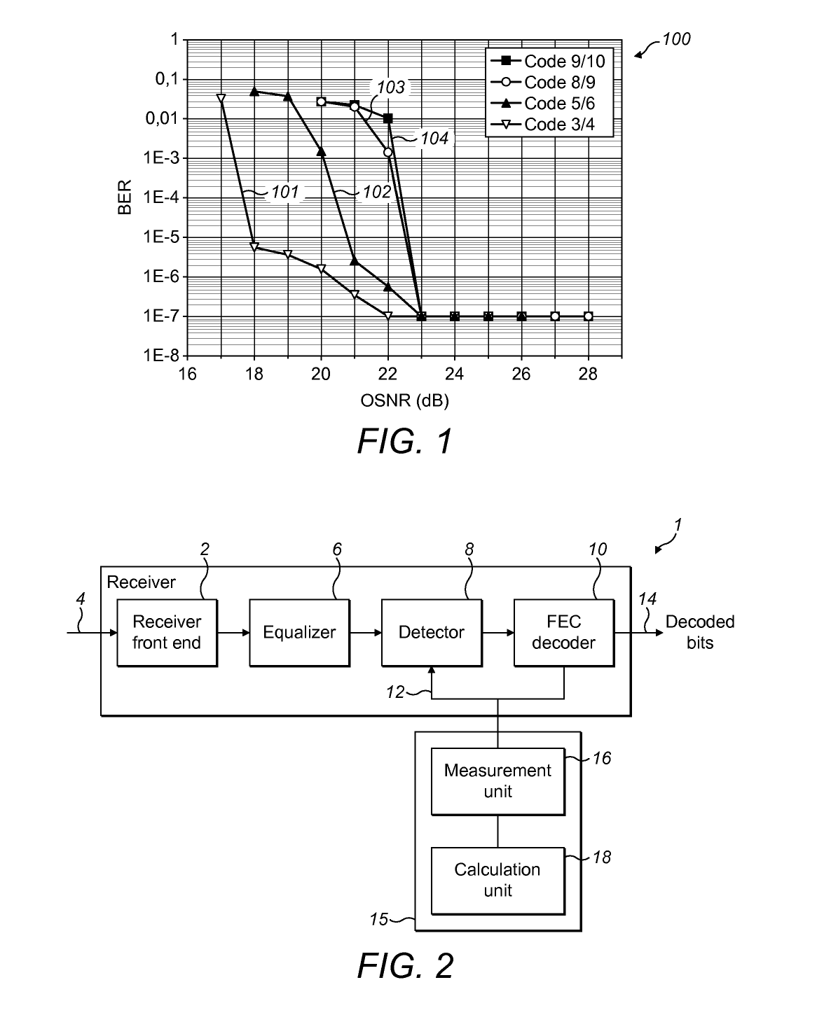

### DETAILED DESCRIPTION

FIG. 2 shows a receiver 1 and a connected determination unit 15. The receiver 1 is a conventional receiver for a coded transmission over a communications link 4, for which an example is described below. The determination unit 15 is configured to determine a transmission quality, e.g. system margin or signal-to-noise ratio (SNR) of the transmission, or determine information to be used in determining the system margin, signal-to-noise ratio (SNR) or a related property of the transmission. The determination unit 15 may be considered as determining a transmission quality, which term includes SNR, BER and system margin. The transmission quality is the quality as observed at the receiver side.

The receiver 1 comprises a front end 2 configured to receive the transmission over the communications link 4. The front end 2 is connected to an equaliser 6. An output of the equaliser 6 is connected to a detector 8. The detector 8 is a symbol detector configured to detect symbols of the transmission. An output of the detector 8 is connected to a decoder 10. The decoder 10 is a forward error correction (FEC) decoder configured to decode the FEC coded transmission. The FEC decoder 10 may be of any type, and examples are described below. The decoder 10 outputs the final decoded transmission as output 14.

An output of the decoder 10 is connected to the detector 8, in order to iteratively detect and decode the transmission. As is known, iteration messages are passed from the decoder 10 to the detector 8, to provide for improved detection of the symbols. The detection and decoding steps are performed a plurality of times, using iteratively updated information.

In this example, information is iteratively passed along a connection 12 between the detector 8 and decoder 10 until the transmission is considered as decoded. Thus, the detector 8 and decoder 10 operate in a “turbo principle”, i.e. the receiver 1 is a Turbo receiver.

The determination unit 15 is configured to monitor the iteration operation between the detector 8 and decoder 10. For example, the determination unit 15 measures messages exchanged between the detector 8 and decoder 10. In particular, the determination unit 15 measures a value of an iteration parameter of the iteration. For example, the iteration parameter may be an error indicating parameter indicating an error in the received transmission. For example, the iteration parameter is count of error indicating events. In particular, the iteration parameter may be the number of iterations in the iterative operation, e.g. of information for a bits sequence. The count of iterations may be the total count of iterations until the right (or final) bits sequence is detected.

The number of iterations may be considered as an example of an error indicating parameter, since the number of iterations will increase as the number of received errors in the transmission increases. In this case, an error indicating event is an iteration between the decoder and detector, until the iterative operation is considered complete. In some aspects, the total number of iteration messages may be counted instead of the number of iterations. The content or type of the iteration messages is not used to determine an error indicating event.

In some examples, the determination unit 15 is considered as comprising a measurement unit 16 and a calculation unit 18. The monitoring of the iteration operation is carried out with the measurement unit 16, which is a functional part of the determination unit 15. The determination unit 15 is connected to the connection 12, or interface of the connection 12, between the decoder 10 and detector 8, or may be connected to any part of the receiver to record an aspect of the iterative operation or iteration messages, e.g. connected to the decoder 10 or detector 8.

The determination unit 15 is configured to calculate a transmission quality of the transmission as received. For example, the determination unit 15 is configured to calculate the system margin, signal-to-noise ratio (SNR), received BER or related property of the transmission over the communications link, based on the received value of the iteration parameter. For convenience, reference to any of the transmission quality, system margin, signal-to-noise ratio (SNR), or related property of the transmission may interchangeably refer to any term.

The determination unit 15 functions to calculate the system margin based on the iterative operation of the receiver 1. This is in contrast to calculating the system margin based on a measured post-decoding BER. In some aspects, the determination unit 15 measures an iteration parameter, e.g. count of the number of iterations, between the detector 8 and decoder 10.

For example, the determination unit 15 comprises the calculation unit 18 configured to calculate the system margin. The calculation unit 18 is connected to the measurement unit 16, for receiving the value of the iteration parameter. The determination unit 15 may comprise a processor and a memory configured to carry out the functions described.

The determination unit 15 records the final value of the iteration parameter, and calculates the system margin directly or indirectly from the value of the iteration parameter. For example, the determination unit 15 (e.g. calculation unit 18) may comprise or have access to a look-up table, for example, stored in a memory. In one aspect, the value of the iteration parameter is used to generate (e.g. look-up) a SNR value. This SNR value is the actual SNR of the transmission. The generation of the SNR value may depend on the particular receiver characteristics, e.g. the type of detector 8 and decoder 10, and the FEC code being used. For a relatively high SNR of the transmission, relatively few errors are detected and decoded. As such, the detector 8 and decoder 10 only carry out relatively few iterations until the right bits sequence is detected. If the SNR decreases, more iterations are required until the right bits sequence is detected. The exact relationship between SNR and the iteration parameter is determined experimentally or by computer simulation. The exact relationship between SNR and iteration parameter depends both on the FEC and the detector.

The calculation unit 18 compares the actual SNR value to a threshold SNR value. The threshold SNR value may be particular to the FEC code used. The system margin is defined as the difference between the actual SNR and the threshold SNR. Thus, the calculation unit 18 determines the difference between the actual SNR and threshold SNR to determine the system margin.

Based on the system margin, the determination unit 15 may, in some examples, signal that the FEC code may or should be changed. For example, if the system margin is large (e.g. larger than a threshold) the FEC code rate may be increased to transmit more payload bits at a given bit rate. Alternatively, if the system margin is small (e.g. smaller than a threshold) the determination unit 15 may indicate that the FEC code rate is decreased to ensure reliable operation.

Alternatively, the determination unit 15 calculates the transmission quality, e.g. system margin or BER, or other parameter indicating transmission quality directly, without determining the SNR. For example, the relationship between the iteration parameter and system margin is determined and used to generate the system margin directly.

In one example, the transmission is an optical transmission along an optical communications link. The optical transmission may comprise one or a plurality of optical carriers. In particular, the optical transmission comprises a plurality of optical carriers at spaced frequencies, e.g. frequency division multiplexed.

The optical transmission may be orthogonal or non-orthogonal. In some aspects, the receiver 1 is arranged to receive a non-orthogonal transmission, allowing improved spectral efficiency. The transmission may be time and/or frequency packed. The receiver 1 is configured to recover the resulting inter symbol interference (ISI) and/or inter carrier interference (ICI). In another example, the transmission is a faster-than-Nyquist transmission. A low order modulation format is used.

For example, the transmission comprises an optical transmission over 100 Gbit/s. In some examples, the transmission comprises seven 28 GHz spaced 160 Gbit/s quadrature phase shift keying (QPSK) optical carriers which are frequency packed, e.g. over a 200 GHz bandwidth. A transmitter for the transmission may generate a complex modulated signal for each sub-carrier. For example, the modulation is QPSK. The signal is narrow filtered, for example in the optical or electrical domain. The filter cut-off frequency is much lower than the baud rate, e.g. 0.25 times the baud rate. This allocates more FDM sub-carriers within a given frequency slot (frequency packing) than the orthogonal requirement. The frequency packing provides an increased spectral efficiency, and the low order constellation of the modulation (e.g. QPSK) is straightforward to generate and decode.

The front end 2 of the receiver 1 is an optical front end, for example, comprising a local oscillator and polarization splitting means. The equalizer 6 may be a feed forward equalizer. The initial stages of the receiver 1 may be as in a common coherent receiver.

In some examples, the detector 8 is a trellis detector. For example, the detector is a Viterbi or Bahl, Cocke, Jelinek and Raviv (BCJR) detector. Such examples of trellis detector are known, and so are not described in further detail. In some aspects, the symbol detector 8 is a maximum a posteriori symbol detector. The output of the detector 8 corresponds to bits, or alternatively, corresponds to transmitted symbols.

The FEC decoder can operate directly on the transmitted symbols or it can operate on bits. In some examples, the detector includes a specific function which transforms the symbols to bits, or, in the case of a soft decision FEC, the symbol error probabilities into bit error probabilities, which are then processed by the (binary) FEC decoder.

The detector 8 may provide soft information to the decoder 10, indicating a reliability of the detection. For example, the output reliability information may be in the form of a log-likelihood ratio (LLR). The decoder 10 is also configured to receive soft information from the detector, and iterate soft information to the detector 8. Therefore, both the detector 8 and decoder 10 are soft input soft output (SISO) devices. In some examples, the determination unit 15 is configured to analyse soft iteration messages.

The determination unit 15 according to an aspect of the present invention is configured to determine the system margin for a system having any of the above features, in any combination. In particular, the determination unit 15 is configured to determine the system margin for a “turbo receiver” having a detector which iteratively exchanges information with a decoder, e.g. a FEC decoder. The determination unit 15 is configured to detect iteration information from the receiver 1 which receives a non-orthogonal transmission, e.g. which is time and/or frequency packed.

The decoder 1 itself may use an iterative operation to decode the transmission. Examples include a decoder 10 for iteratively decoding a Turbo code, low density parity check (LDPC) code or any type of FEC code which may be iteratively decoded. Such an iterative operation of the decoder 10 is separate and independent of the iterative operation between the detector 8 and decoder 10. For example, the iterative decoding operation within decoder 10 comprises one or more iterations prior to information being iteratively passed to the detector 8. The receiver 1 is configured to detect and decode the transmission using one or a plurality of independent iterative operations, of which one or a plurality of iterative operations are used by the apparatus of an example of the invention to determine an parameter of the transmission quality. The determination unit of an example of the present invention monitors one or more of: the iterative operation of the decoder and/or the iterative operation between the decoder and detector. Examples of the determination unit of an aspect of the present invention applied to the iterative operation of the decoder 10 are now described.

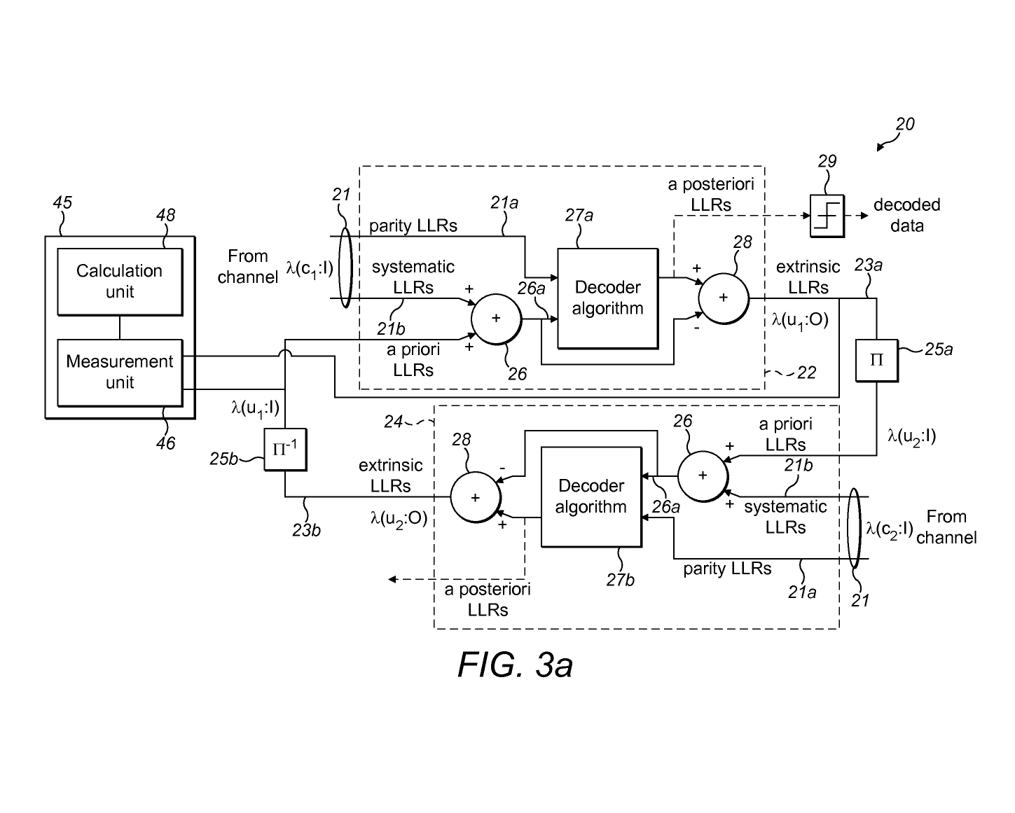

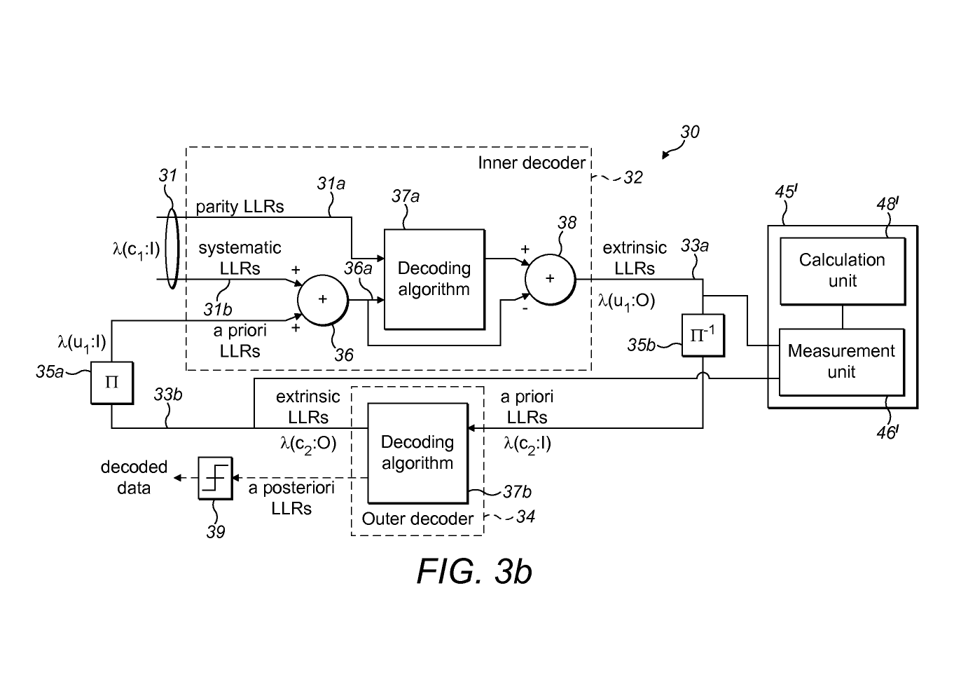

FIG. 3a shows a decoder 20 configured to decode a Turbo forward error correction code. The decoder is configured to decode a parallel code. The decoder 20 is an example of the decoder 10 in FIG. 2. The Turbo decoder 20 functions in a known manner to decode a Turbo code using an iterative operation. Some brief details of the iterative operation are described, and further details or options will be known to a person skilled in the art.

Input values are labelled as λ(;I) and outputs λ(;O). Channel values are labelled λ(c;) and updated vales λ(u;) for each of decoder 1 and 2.

Data λ(c₁;I), λ(c₂;I) is received at inputs 21 from a detector, e.g. detector 8. The inputs 21 are respectively connected to a first decoder 22 and a second decoder 24. The first and second decoders 22,24 iteratively pass information on the result of their separate decoding to the other of the first and second decoders 22,24, in an iterative operation which is measured by an aspect of the invention.

The input data comprises parity information 21a and systematic information of the code 21b, for example, in the form of LLRs. The systematic information 21b is added in adding unit 26 to a priori information λ(u₁;I), λ(u₂;I) (e.g. soft information) from the other of the decoders 22,24. The combined information 26a is input into decoding units 27a,27b comprising the decoder algorithm. The parity information 21a is also input into the decoding units 27a,27b.

The decoded output of the decoding units 27a,27b and the combined input 26a are compared in subtracting units 28. The output λ(u₁;O), λ(u₂;O) of the subtracting units 28 is termed the extrinsic information 23a,23b. The extrinsic information 23a,23b is soft information indicating a more likely bit value, for example in the form of a LLR. The extrinsic information 23a is interleaved in an interleaver 25a, and the extrinsic information 23b is de-interleaved in a de-interleaver 25b. The interleaved or de-interleaved extrinsic information λ(u₁;I), λ(u₁;I) is then passed as a priori information to the other of the decoders 22,24. The decoding operations continue in iterations in turn.

The extrinsic information 23a,23b is used as an additional input to the other decoder 22,24. The first and second decoders 22,24 iteratively exchange extrinsic information. Repeated steps of receiving extrinsic information from the other decoder 22,24 and further decoding the transmission based on the original transmission and the received extrinsic information are made until decoding is considered complete. A final decoding of the transmission is made at output 29 of the a posteriori information once the iteration operation is finished. The magnitude of the value of the a posteriori information indicates the determined probability, which if the final output of the decoding operation, may be sliced for a hard decision on the decoded bit.

The apparatus of an aspect of the present invention may monitor any type of decoder using an iterative operation. The first and second decoders 22,24 are soft input soft output (SISO) devices, i.e. the extrinsic information is soft. The extrinsic information may be in the form of a log likelihood ratio (LLR). For example, the decoders 22,24 are trellis decoders, and for example, using the Viterbi or BCJR, e.g. maximum a posteriori (MAP), algorithm.

In some aspects, the iteration parameter is an error indicating parameter measured by an aspect of the present invention indicating an error in the received transmission. For example, the error indicating parameter is iterative information corresponding or indicating different most likely values (outcomes) for the same information, i.e. different bit values after a hard decision. For example, an error indicating parameter is that the decoders receive or at least partly generate information used in the iterative operation which corresponds to different values of bit. As such, the iteration parameter is based on a content or type of the iteration message.

The error indication parameter may be measured by measuring the extrinsic information. Extrinsic information corresponding to different decoded bit values for the two decoders is used as an error indicating parameter in an aspect of the present invention. For example, a sign of the soft extrinsic information is an example of a property of the extrinsic information which may be used to indicate an error in the received transmission. Extrinsic information indicating different values is counted by an aspect of the present invention as an error indicating event.

The soft extrinsic information comprises a magnitude corresponding to a likelihood and an indication of the most likely value. The most likely particular value can be considered as corresponding to the value of the bit if a hard decision is made on that soft information. For example, the sign (e.g. plus or minus or most significant bit in 2′s complement representation) of the extrinsic information may be considered to indicate the most likely decoded value (e.g. 1 or 0). For example, positive soft information corresponds to the bit being most likely a 1, and negative soft information corresponds to the bit being most likely a 0. The higher the magnitude of the soft information, the higher the certainty. Examples of the present invention measure a count of the error indicating events where iterative message information corresponding to most probable value of a part of the transmission differs between decoders 22,24.

An example of the present invention comprises a determination unit 45, configured to determine a transmission quality (e.g. SNR or system margin) in a corresponding manner to the determination unit 15. The determination unit 45 is configured to monitor (e.g. count) one or more iteration parameters, for example, the iteration messages (extrinsic information) exchanged between the first decoder 22 and second decoder 24. In particular, the determination unit 45 comprises a measurement unit 46 configured to measure a value of one or more iteration parameter of the iteration. Alternatively, the iteration parameter may be a count of bits for which there is a difference in the most likely value of the bit between the decoders.

In some aspects, the determination unit 45 is connected to both of the connections 23a,23b or their interfaces used to pass iteration messages. Alternatively, the determination unit 46 may be connected to only one of the connections 23,27.

For example, the iteration parameter observed is an error indicating parameter. In particular, the error indicating parameter is the number of error indicating events which indicate a received error in the transmission. The error indicating parameter may be based on iteration information passed in the iterative operation. The error indicating parameter may be based on iteration messages, for example, a count of the error indicating iteration messages.

The error indicating events measured may be the decoders indicating a different value (e.g. most likely outcome) for the same information (bit). For example, the measurement unit 46 of an aspect of the present invention uses a measurement (e.g. count) of the extrinsic information messages 23a,23b which indicates a difference in the most likely decoding determination (e.g. 1 or 0). For example, the iteration parameter is based on a sign difference of the extrinsic information between the two decoders. The sign difference is monitored by the determination unit 45, and the number of extrinsic information messages having a sign difference is counted. The sign difference corresponds to a different value of the decoded bit for the decoders 22,24 as the most probable. The extrinsic information of the two decoders is compared for the same iteration.

A difference in the sign of the extrinsic information corresponds to a difference in the most likely decoding outcome from the first and second decoders 22,24 for a corresponding bit. For example, a received error in the transmission is indicated by iteration messages which are associated with different bit values, e.g. indicated by a difference in sign of the extrinsic information. For example, a sign change of the LLR for a bit from positive to negative or negative to positive in an iteration may be counted as an error indicating event. The number count, or sum of the magnitude of a plurality of differences, of error indicating events may be used as an iteration parameter to determine the SNR.

Alternatively, an iteration parameter measured may be the number of iterations or number of extrinsic information messages passed. The determination unit 45 is connected to only one of the connections 23a,23b, or to another part of the decoder 20.

A calculation unit 48 is connected to the measurement unit 16, and configured to calculate the system margin, signal-to-noise ratio (SNR) or related property of the transmission over the communications link, based on the received value of the iteration parameter, as explained with respect to the calculation unit 18 in FIG. 2. The calculation unit 48 performs the calculation or look-up based on the particular iteration parameter being measured.

FIG. 3b shows a decoder 30 configured to decode serially concatenated codes. For example, the codes are convolutional codes. Such codes are also known as serial turbo codes. The decoder 30 is a further example of a Turbo decoder, from which an aspect of the present invention determines a transmission quality is applicable. The decoder 30 comprises an inner decoder 32, as is known. The inner decoder 32 receives input information 31, λ(c₁;I), comprising parity information 31a and systematic information 31b, substantially as described above. The inner decoder 32 comprises a decoding algorithm 37a. The decoding algorithm 37a receives an input of the parity information 31a, and a sum 36a from adding unit 36 of the systematic information 31b and a priori information λ(u₁;I) from the other decoder, outer decoder 34. The inner decoder algorithm 37a outputs decoded values as soft information. In this example, the inner decoder 37a output is to a subtraction unit 38, which determines a difference from the input 36a. The output λ(u₁;O) of the subtraction unit 38 is termed the extrinsic information 33a.

The extrinsic information is de-interleaved in a de-interleaver 35b and passed as an input λ(c₂;I) to the outer decoder 34. The outer decoder 34 comprises a decoding algorithm 37b configured to decode, as is known in the art. An output λ(c₂;O) of the outer decoder 34 is interleaved in interleaver 35a, and passed as a priori information to the inner decoder 32. Output 33b, λ(c₂;O), of the outer decoder 34 is considered as extrinsic information.

When the iterations are considered complete, a posteriori information 39 is taken from the output of the outer decoder 34.

A determination unit 45′ comprises a measurement unit 46′ and calculation unit 48′, substantially as described above with respect to the determination unit 45, measurement unit 46 and calculation unit 48. The determination unit is connected to the decoder 30 to measure an iteration parameter, e.g. extrinsic information from one or both of the decoders. As described above, the determination unit determines a transmission quality based on one or more iteration parameter, e.g. an error indicating parameter, and in particular, based on error indicating events. The transmission unit may be configured to measure iteration messages which indicate an error, for example, a count of iteration messages which indicate an error. The error indicating events may be an event (e.g. extrinsic information) from the two decoders which differs in the indication of bit value, e.g. number of sign differences of extrinsic information. The iteration parameter is based on a content or type of the iteration message. For a serial code there is a common subset of (permuted) extrinsic information, which is compared in an aspect of the present invention.

The codes may be block codes or convolutional codes. In some aspects, the convolutional codes are effectively processed as block codes.

In some aspects, the extrinsic information exchanged between decoders in any embodiment directly indicates the most likely decoded bit value, e.g. a 1 or 0. For example, the sign of the extrinsic information indicates this information.

Alternatively or in addition, the iteration parameter may be a count of the number of iterations during the iterative operation. This count includes iterations both with and without a sign difference in the extrinsic information. The count of iterations may be the total count of iterations until the sequence is decoded.

Alternatively, the iteration parameter may be any value generated in an iteration operation, not limited to the iteration messages passed. For example, an output of the first and second decoders may be measured during the iteration operation. This output is the a posteriori information, although in a known decoding operation this would not be output before the decoding operation has finished. Differences in the output of the two decoders indicating a difference in bit value (e.g. a sign difference) may be used as the iteration parameter. The count of the differences is used to determine the transmission quality.

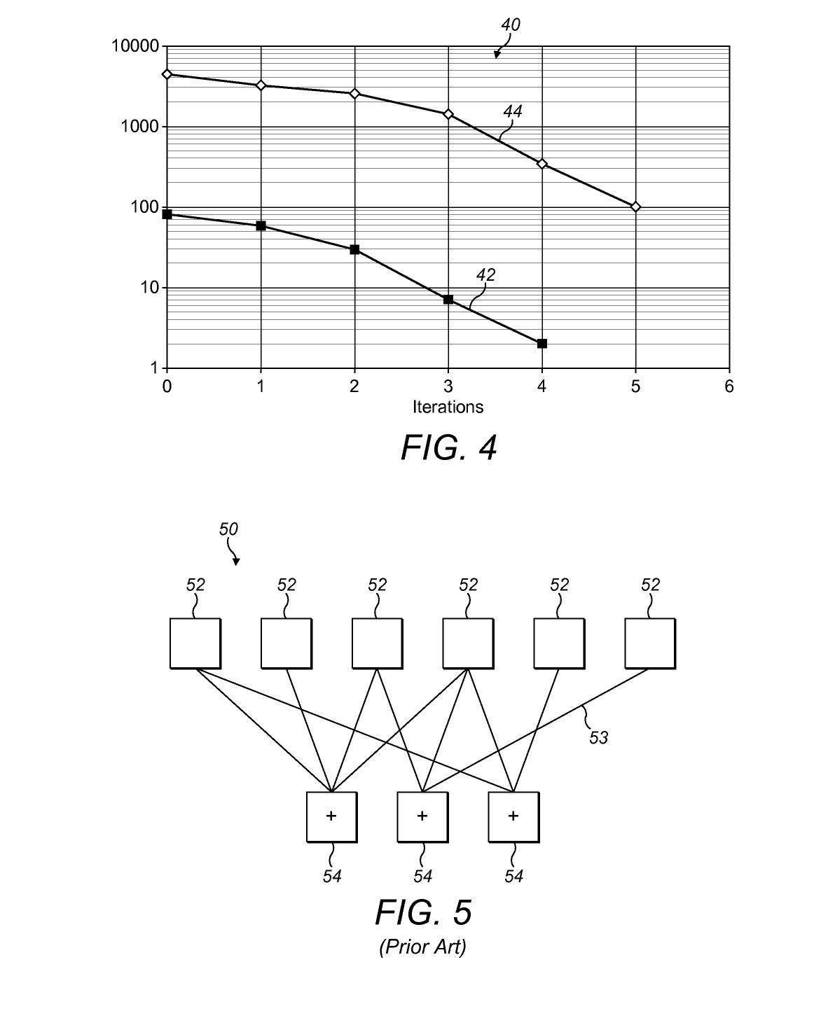

FIG. 4 shows a graph 40 illustrating the number of errors 42 in the transmission during the iteration operation of a Turbo decoder, against the number of iterations of the FEC decoder 20. The BER 42 is reduced during the iterations of decoding.

FIG. 4 also illustrates the number of error indicating events in the iteration operation, in this case, the number of sign differences 44 in the extrinsic information. The graph shows a number of sign differences 44 at each iteration. For example, the graph 40 shows that the log of the BER 42 is substantially proportional to the log of the number of extrinsic information sign differences at each iteration.

The number of errors 42 received and prior to decoding (i.e. at 0 iterations) can be considered as a bit error rate (BER) of the transmission as received at the receiver 1. This number of errors prior to decoding (i.e. transmission BER) is directly related (e.g. proportional) to the SNR of the transmission. Thus, a measurement of the iteration parameter (e.g. based on the error indicating events) may be converted to a parameter of transmission quality, e.g. by the calculation unit 28;28′. The measurement of the iteration parameter may be converted to the received BER (e.g. equivalent to the BER before decoding), or the received BER or iteration parameter values used as information to provide direct conversion to another transmission quality parameter, e.g. SNR or system margin.

In some examples, the determination unit of any embodiment uses measurements from one or more iterations. For example, information from a plurality of iterations is measured, and processed to determine the BER. The convergence of the FEC decoder and/or an integrated measure (e.g. count of error indicating events) from a plurality of iterations is used to determine the input error distribution. The use of measurements combined over a plurality of iterations may average (and reduce) the noise of the measurement.

The number of transmitted errors 42 is not directly measurable at the receiver 1, and the line shown is a simulation of the errors.

In some aspects, the FEC code has a block length. The measurements are for one FEC block, although different measurement lengths may be used.

The number of error indicating events 44 (e.g. extrinsic information sign differences) is related to the number of errors 42. In particular, both values 42,44 reduce at approximately the same rate as the number of iterations increases. Measurement of the error indicating event as the iteration parameter may be used to determine the number of errors 42 prior to the receiver, and hence the SNR.

The SNR may be calculated directly from the error indicating events. In particular, a number of error indicating events is converted directly to a SNR (or related parameter), e.g. with a look-up table for the particular receiver 1.

The conversion of error indicating events to SNR may be based on a measurement at a single iteration, or based on measurements recorded over a plurality of iterations.

The conversion of error indicating events to SNR may be based on a value determined or simulated at one or more iterations including or excluding the 0 iteration value, e.g. the 1^{st}, 2^{nd} or any iteration number value may be used as the basis to calculate the SNR using the known relationship.

FIG. 5 shows a prior art Tanner graph 50 for illustrating the basic principle of an LDPC code decoder. The LDPC code can be decoded iteratively, and aspects of the present invention relate to determining the SNR based on the iterative decoding operation of an LDPC code. An LDPC code decoder may be used as the decoder in the receiver, and the iterative decoding operation monitored by the method and apparatus of an aspect of the present invention.

The LDPC decoder implements a message passing algorithm as an iterative operation. Variable nodes 52 (or variable bit nodes) contain the decoded transmission bits. Check nodes 54 (or parity check nodes) carry out a parity check on variable nodes connected by connections 53. The connections 53 are defined by a sparse parity-check matrix. An iteration of decoding comprises a round of message passing from each variable node 52 to all relevant check nodes 54, followed by another round of message passing from each check node 54 to the relevant variable nodes 52. Repeated iterations are carried out until a stopping threshold is reached. Aspects of the present invention are applicable to any implementation of iterating LDPC or linear block code decoder.

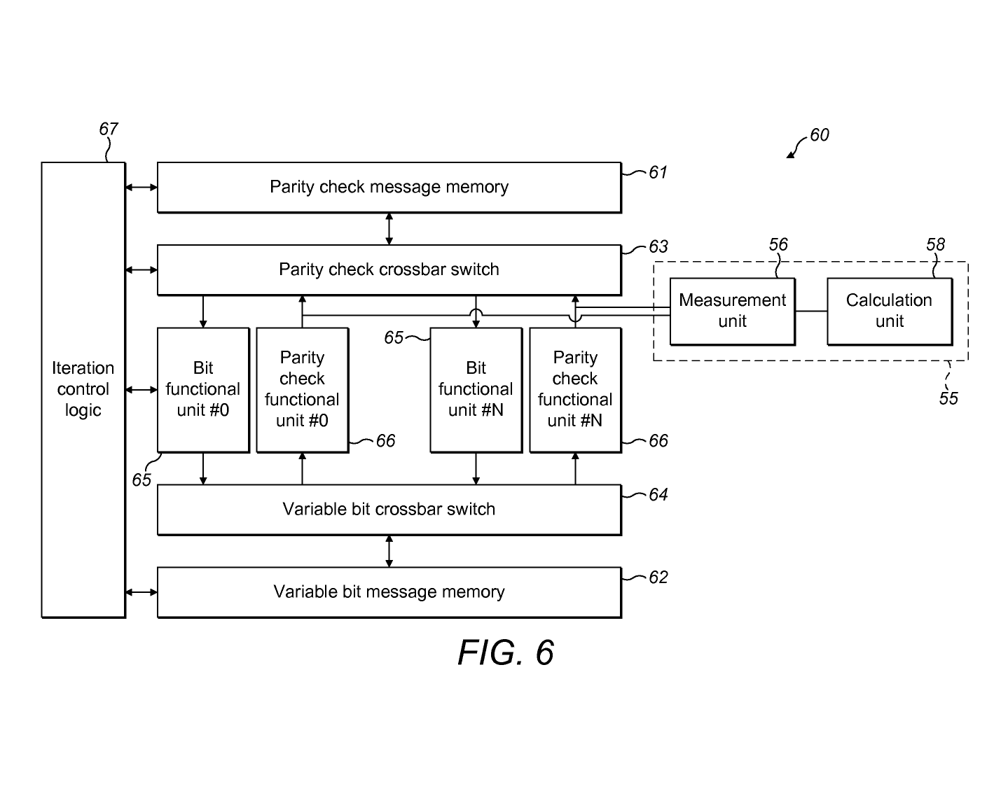

FIG. 6 shows functional units forming an example LDPC decoder 60. Parity check information of the parity check nodes is stored in a parity check message memory 61. Variable bit information of the variable nodes is stored in a variable bit message memory 62. A parity check crossbar switch 63 connects the parity check message memory 61 to a plurality of bit functional units 65 and a plurality of parity check functional units 66. A variable bit crossbar switch 64 connects the variable bit message memory 62 to the bit functional units 65 and parity check functional units 66. The decoder 60 comprises N bit functional units 65 and N check functional units 66, and only a 0th and Nth bit functional unit 65 and check functional unit 66 are shown for clarity. Iterations of the decoder are controlled by an iteration control logic 67. The iteration control logic is connected to at least one of the bit functional units 65, parity check functional units 66, variable bit crossbar switch 64, variable bit message memory 62, parity check crossbar switch 63 and the parity check message memory 61, to control the iteration operation of the decoder.

The bit functional units 65 are configured to compute for each bit node a message corresponding to each of its check node neighbours. The message is passed to the variable bit message memory 62, through the variable bit crossbar switch 64.

The parity check functional units 66 are configured to compute for each check node a message corresponding to each of its bit node neighbours. The message is passed to the parity check message memory 61, through the parity check crossbar switch 63.

The computation of check-to-bit messages and bit-to-check messages is iterated until the decoding is considered complete.

A determination unit 55 is configured to determine a transmission quality, e.g. SNR or system margin, as described for the other embodiments of determination unit, configured for a LDPC code. The determination unit 55 comprises a measurement unit 56 configured to measure an iteration parameter, and a calculation unit 58, substantially as described above for other embodiments of the calculation unit and configured for the iteration parameter corresponding to the FEC code of the decoder.

In some aspects, the determination unit 55 is connected to the decoder to measure an iteration parameter, to calculate a SNR or related property of the transmission. The determination unit 55 may be connected to one or more points in order to obtain the required iteration information. In the example shown, the determination unit 55 is connected to measure iteration messages, e.g. bit-to-check messages from the parity check functional unit 66.

In some options, a corresponding connection is made for each parity check functional unit 66. Alternatively, the connection of the determination unit 55 is to any of the iteration control logic 67, bit functional units 65, parity check functional units 66, variable bit crossbar switch 64, variable bit message memory 62, parity check crossbar switch 63 and the parity check message memory 61, or any other part of the FEC decoder.

The iteration parameter measured by the determination unit 55 may be a count of iterations in the iterative operation, e.g. prior to decoding finishing. Alternatively, the iteration parameter is a count of iteration messages transmitted or parity check iteration messages transmitted. The count may be for one or more blocks of code.

In some examples, the iteration parameter observed is an error indicating parameter. In particular, the error indicating parameter is the number of error indicating events which indicate a received error in the transmission. The error indicating parameter may be based on iteration information passed in the iterative operation. The error indicating parameter may be based on iteration messages, for example, a count of the error indicating iteration messages.

In particular, the iteration parameter is a count of error indicating events. The error indicating events may be failed parity check events. The determination unit 55 is configured to detect any suitable message or event which indicates the iterative decoder has detected a failed parity check. As such, the iteration parameter is based on a content or type of the iteration message. For example, the parity check functional units 66 compute a parity check based on the connected variable bit values. A failed parity check may be indicated by the sum of the variable bits not being equal to zero, modulo 2. When soft information is used, the probability that a parity check is satisfied is computed. A failed parity check is indicated by a probability indicating a higher likelihood of an unsatisfied parity check. In particular, the failed parity check indicates there is a higher likelihood of an unsatisfied parity requirement than a likelihood of a satisfied parity requirement.

A failed parity check event may be the transmission of the parity check sum from the variable bit memory or parity check function units 66. Alternatively or in addition, the failed parity check event may be the transmission of a message to/from the variable bit functional units 65 with a changed value of the variable bits in response to a failed parity check.

Any of the counts mentioned may be a total count prior to completion of the iteration operation; or a count at one or more iteration, or within a particular time period or time window.

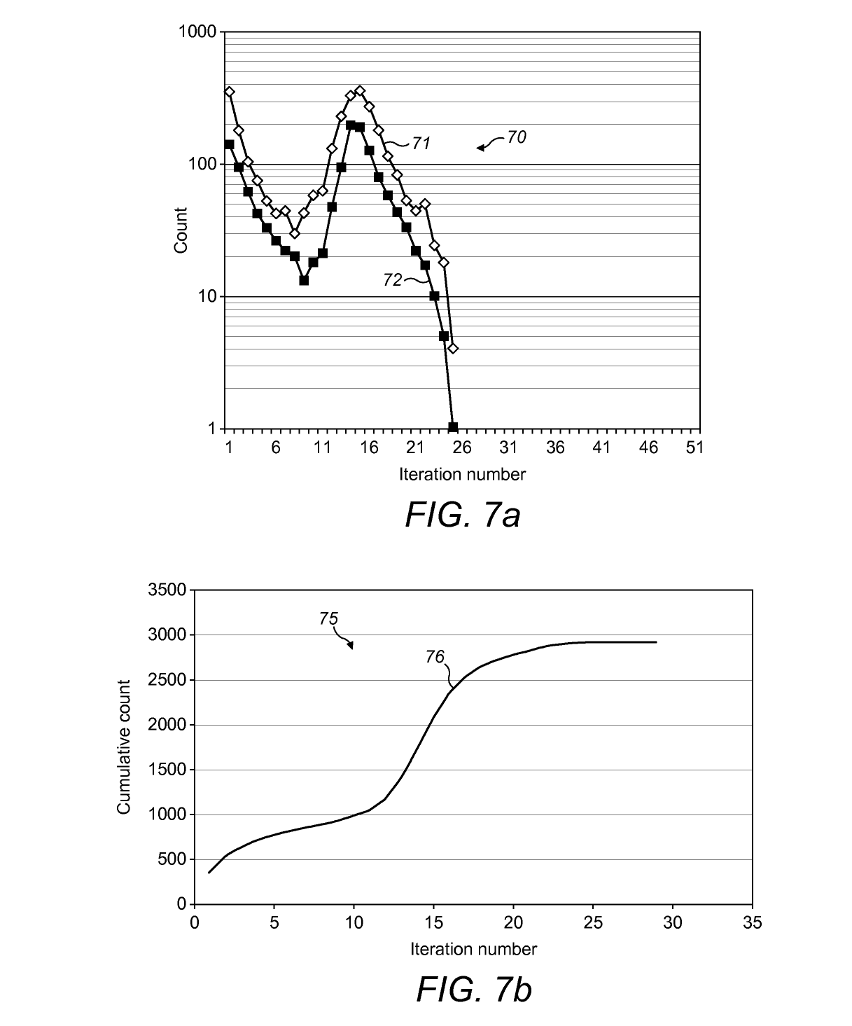

FIG. 7a shows a graph 70 illustrating the relationship between a number of failed parity check events 71 and bit errors 72 as received in the transmission, at each iteration in the iterative decoding operation. As discussed above, the number of bit errors 72 in the transmission is directly (e.g. proportionally) related to SNR, and so the number of bit errors 72 may be replaced by SNR or a related quantity.

The graph 70 shows that the number of bit errors 72 closely follows the number of failed parity check events (messages) 71. Therefore, measuring the number of failed parity check events may, with prior knowledge of the decoder characteristics, provide the SNR of the transmission or bit errors in the transmission prior to decoding.

The determination unit 55 may count the number of failed parity events at one or more iteration, and use this information to calculate the SNR, e.g. in the calculation unit 58.

A simulated or experimental decoding on known data is carried to establish the relationship to convert the measured quantity (e.g. failed parity checks) for the particular type of receiver. In the case of LDPC codes there is a direct proportionality between the number of failed parity checks and the bit errors received.

The graph 70 shows that a transient phase in the iteration exists where the number of failed parity check events increases, before decreasing to a low value (or zero) at which the decoding is considered complete and iterations stop. In this example, the transient phase extends to around 14 iterations, although a different behaviour will generally result from a different error pattern at the input of the LDPC decoder. An aspect of the present invention is configured to measure failed parity check events over a pre-determined time slot, for example, for longer than a maximum expected transient time. For example, the decoding may show a monotone convergence or a constant region with a high number of error/failed checks followed by a converging behaviour.

FIG. 7b shows a graph 75 of the cumulative number of failed parity check events 76 with iterations during decoding. The cumulative number 76 increases as the iterative operation continues. The cumulative number increases only relatively slowly when decoding is almost complete. The cumulative count of iterative messages, e.g. failed parity check events, may be used as the iteration parameter, since the value may be used to calculate the bit errors or SNR of the transmission. The cumulative count of error indicating events, e.g. iterative messages, may be used as the iteration parameter for any embodiment.

In some examples, the accumulated failed parity check events are counted by the determination unit. The count is stopped when the increase of the count is less than a threshold value. In some aspects, the count is only stopped when a condition is satisfied, e.g. the increase of the count is less than the threshold value over a pre-determined number of consecutive iterations. For example, the count of the events increases by less than a threshold of 1% over 10 consecutive iterations.

In some aspects, the iteration number at which the count is stopped is used as the iteration parameter (i.e. the number of iterations). The value of the iteration parameter is converted to a SNR with a pre-determined conversion factor, e.g. using a look-up table or pre-calculated function. For example, the look-up table contains SNR versus the iteration number at which the count stopped and/or number of failure events. In particular, the SNR or transmission quality is determined based on two (or more) parameters, e.g. a plurality of iteration parameters. The parameters may be the number of iterations and the number of error indicating events (e.g. failed parity checks).

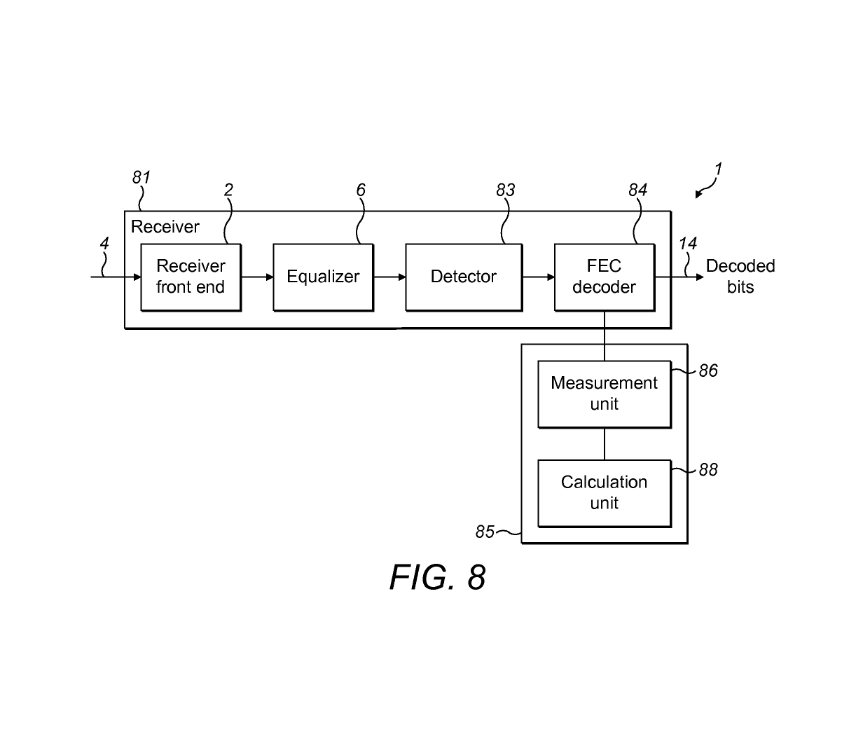

FIG. 8 shows a further example of receiver 81 to which a determination unit 85 according to an aspect of the invention is configured to attach. The receiver 81 receives a transmission 4, and comprises a receiver front end 2 and equalizer 6, as described for the receiver 1 above. The receiver 81 further comprises a detector 83, configured to detect symbols of the transmission. The detector 83 is a conventional detector of any suitable type. The receiver 81 further comprises a decoder 84 connected to an output of the detector 83. The detector 83 is configured not to iterate with the decoder 84, and thus is different to the receiver 1. The detected transmission is passed to the decoder 84, which outputs decoded bits 14. The decoder 84 is any type of decoder using an iterative operation, e.g. a Turbo or LDPC decoder as described above. The receiver 81 illustrates that the determination unit 85 is applicable to a receiver in which the only iterative operation is in the decoder 84.

The determination unit 85 comprises a measurement unit 86 and calculation unit 88, substantially as described with respect to the measurement unit and calculation unit of any embodiment(s) described, and configured for the particular type of decoder 84 to which the determination unit 85 is attached.

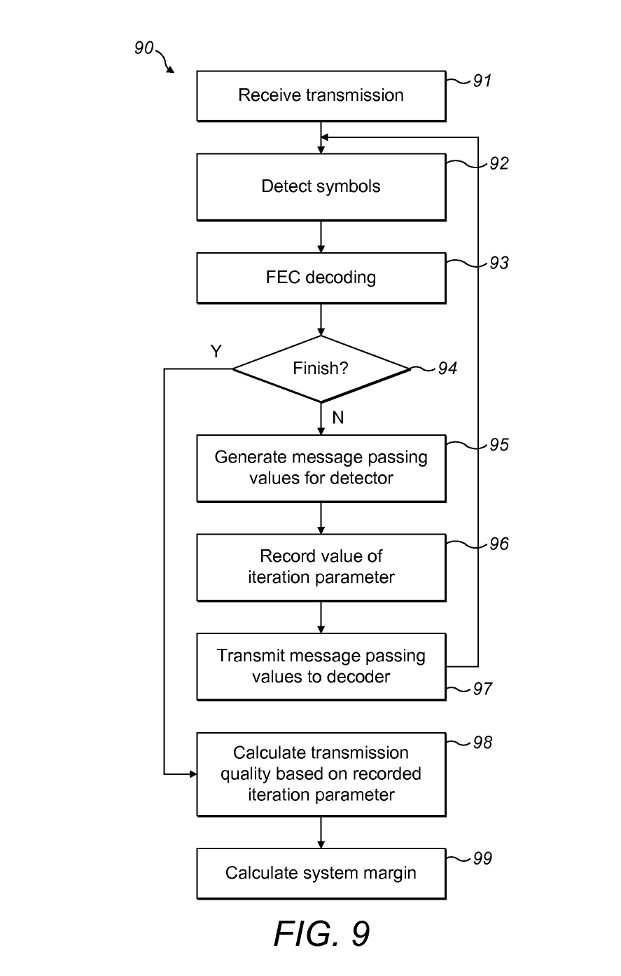

FIG. 9 shows a method 90 according to an aspect of the present invention. In particular, the method corresponds to a method of using an iteration parameter of an iterative operation between a detector and decoder, as shown in FIG. 2.

In 91, a transmission is received by a receiver. The transmission comprises symbols. The transmission may be over any type of media, e.g. an optic fibre. In 92, the detector detects the symbols of the transmission. In 93, decoding is carried out on the detected symbols. For example, the detecting is carried out by a detector, which may or may not itself be an iterative detector.

In 94, it is determined whether errors exist in the decoded transmission which require further detection/decoding. Generally, a plurality of iterations will be required, and the method as shown assumes that at least one iterative message is passed back to the detector. In 95, such an iterative message is generated by the decoder. In 96, the determination unit of any example of the present invention records a value of an iteration parameter associated with the iterative message to the detector. For example, the iteration parameter may be a count of the messages, or a count of the number of iterations. The iterative message is passed to the decoder in 97, and a further detection is carried out in step 92 at least partially using the extrinsic information in the iterative messages. The detection and decoding continue to operate, e.g. passing messages indicating bit value likelihoods from the detection, to assist in decoding, until decoding is considered complete.

If the decoding is considered complete, the detecting/decoding operation finishes. The transmission quality, e.g. SNR, bit error, or related parameter of the transmission is calculated in 98 based on the measured value of the iteration parameter. Optionally, the system margin is calculated in 99, as an alternative or addition to the SNR.

The SNR or system margin may be used in a further step to change the transmission system. For example, based on the calculated SNR or system margin, the FEC and/or transmission path are changed. The transmission system is changed to maintain the system margin or SNR within threshold limits.

The above method is exemplary of a possible embodiment, and a skilled person will appreciate that many alternatives are possible. For example, the transmission quality, e.g. SNR or related property may be calculated prior to the decoding operation being complete. For example, a measure of the number of error indicating messages at a particular iteration (e.g. 2^{nd} iteration) may allow calculation of the SNR.

The order of the steps shown is only one option, and a different order of any step which achieves the overall function is possible. For example, the decoding the value of the iteration parameter does not need to occur prior to transmission of the iterative message to the decoder. The recording of the iteration parameter may be made at any point in the iterative operation. The recording of the iteration parameter may occur at any time, e.g. after receipt of the iterative message by the detector, or before or during generation of the iterative message. The recording of the iterative parameter may alternatively occur during or after detection, or prior to, during or after decoding.

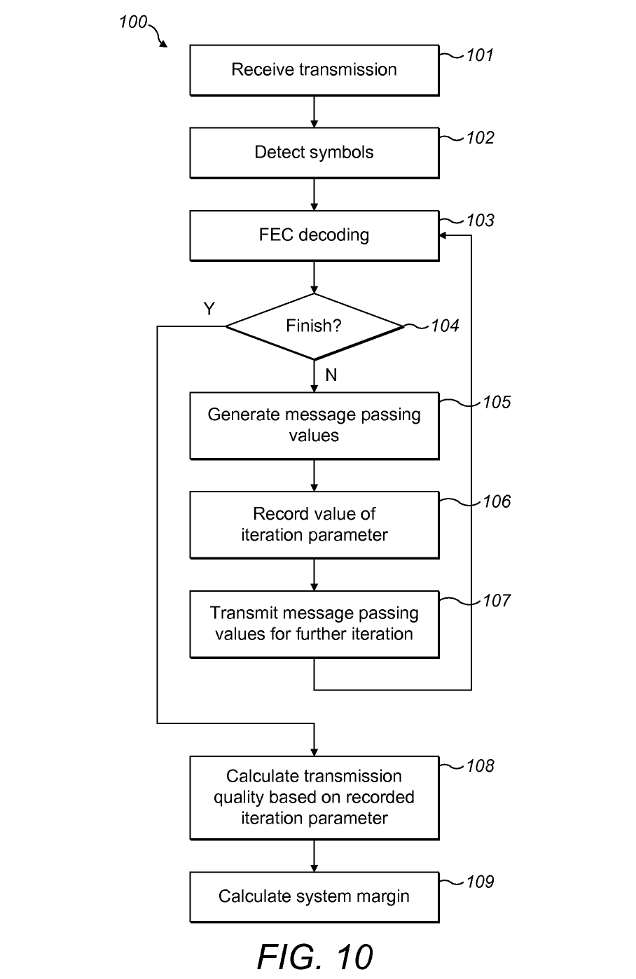

FIG. 10 shows an exemplary method 100 of the present invention, in which the transmission quality, e.g. SNR or related property is based on an iterative operation within the decoder. This iterative operation of the decoder may be within an independent detector-decoder iterative operation, or following detection (with no iterative operation back to the detector).

A transmission is received at 101, and the symbols detected in 102. Decoding is carried out in 103. At 104, the method determines whether the iterative operation stops, or a further iteration should be executed. It is assumed that at least one decoding iteration is made.

The decoding continues in 105 by the generation of extrinsic information or message passing values, to iteratively pass information to assist in decoding. A value of the iteration parameter is recorded at any point in the iterative operation in 106, which is not limited to the particular position shown in the method. The iteration parameter may be based on the content or type of the iteration message, for example, by comparing iteration messages with each other or a pre-determined threshold, content or type. The iteration information is transmitted or passed in 107, to continue with a further iteration.

When the decoding is considered complete in 104, the transmission quality, e.g. SNR, bit error, or related parameter of the transmission is calculated in 108 based on the measured value of the iteration parameter. Optionally, the system margin is calculated in 109, as an alternative or addition to the SNR. Optionally, the system is re-configured based on the determined transmission quality.

As described above, the SNR or related property may be calculated prior to the decoding operation being complete.

The determination unit of any embodiment comprises any combination of software, firmware or hardware to carry out the functions and operations described. In particular, the measurement unit and calculation unit may not be separate in software, firmware or hardware, i.e. may be integrated. The determination unit of any embodiment may comprise a processor and memory configured to carry out the method and functions described.

One or more of the functions or components of the determination unit may be separate or distributed. For example, recorded values by the determination unit may be transmitted to a processor or server at a remote location for calculation of the SNR. In some aspects, the determination unit is a functional unit within the receiver, configured to measure the iteration parameter. The calculation unit is optionally within the receiver. The receiver may be configured to change the FEC based on the SNR or system margin determined. For example, the FEC may be changed until the FEC code can be selected with an overhead which is high enough (code rate low enough). In particular, the FEC is selected such that the (optical) SNR tolerated by the FEC is less than the (optical) SNR at the receiver 1 or end of the path. Therefore, an aspect of the present invention is a receiver configured to measure SNR or system margin, and optionally, change the FEC based on the determination to advantageously meet the system requirements of reliability and speed of transmission.

Aspects of the present invention allow a determination of transmission quality, SNR or system margin in working ultra-high speed optical channels, e.g. above 100 Gbit/s. In particular, the method or determination unit of the present invention is configured to determine SNR or system margin of a channel operating above 100 Gbit/s by measuring an iteration parameter. For example, the optical channel may be above 200 Gbit/s, 400 Gbit/s or 1 Tbit/s. This determination may prevent channel failures and allow consequential actions to be taken to ensure quality of service, e.g. by re-routing a path or an optical path. The signal-to-noise ratio or related transmission quality parameter may be determined in real time.

In some aspects, the error indicating parameter is based on only those iteration messages which are specifically determined to indicate an error. The number of error indicating iteration messages is less than the total number of iteration messages. The iteration messages are analysed to determine a content, and the iteration parameter based on the message content.

Aspects of the present invention are applicable to any code in which the detection and/or decoding uses an iterative or belief propagation algorithm. For example, aspects may be applicable to Tornado codes, LT codes or raptor codes.

Aspects of the present invention have been described as measuring an iteration parameter of particular implementations of decoder and detector. Aspects of the present invention are also applicable to different implementations of decoder and detector carrying out a similar iterative operation. The implementations of decoder and detector shown are examples only, and a person skilled in the art is able to provide alternatives and further details if necessary.

The detector and decoder have been described as soft-input and soft-output. Alternatively, one or both of the detector or decoder use hard decision detecting or decoding.

Any reference to SNR may be substituted by optical signal-to-noise ratio (OSNR).

The determination of transmission quality may be based on a combination of two or more iteration parameters. For example, the iteration parameter for any embodiment may be one or more of: number of iterations, number of iterative messages passed, or number of error indicating events (e.g. parity check error events or sign difference in extrinsic information). In particular, the iteration parameters used to determine transmission quality are number of iterations and/or number of error indicating events.

The iteration parameters measured may be from one or more iterative operations in the receiver. For example, if a plurality of iteration parameters are measured, one (or more) may be from the iterative operation between the detector and decoder, and one (or more) may be from the separate iterative operation within the decoder. For example, a number of iterations between the detector and decoder is measured as a first iteration parameter, and a number of error indicating events in the iteration operation within the decoder is measured as a second iteration parameter. The transmission quality is determined based on the first and second iteration parameter.

The error vector magnitude (EVM), which is sometimes also referred to as receive constellation error RCE, is a measure used to quantify the performance of a digital transmitter or receiver (e.g. for radio or photonics). EVM may be calculated as a transmission or signal quality parameter, as an alternative to SNR. A signal sent by an ideal transmitter or received by a receiver would have all constellation points precisely at the ideal locations. Various imperfections in the implementation and transmission (such as carrier leakage, low image rejection ratio, phase noise) cause the actual constellation points to deviate from the ideal locations. EVM is a measure of how far the points are from the ideal locations.

The determining apparatus may alternatively be termed a testing apparatus or a transmission quality determining apparatus.

The iteration parameter of any embodiment is a count over a pre-determined amount of time, a count at one or more iterations or a cumulative count.

One or more functions of the apparatus or steps of the method may be performed at a separate apparatus or a separate time. For example, the value of the iteration parameter determined may be transmitted to a remote location for determining of the SNR or system margin.

Any aspect of any embodiment may be combined with any feature of any other embodiment.

1. A method of determining a transmission quality of an optical transmission, the method comprising:
detecting and/or decoding the optical transmission using an iterative operation,
generating a value of one or more iteration parameter of the iterative operation, and
calculating the transmission quality based on the value of the one or more iteration parameter.

2. The method as claimed in claim 1 wherein detecting and/or decoding the transmission using an iterative operation comprises detecting and decoding the transmission using an iterative operation between the detecting and decoding.

3. The method as claimed in claim 1 wherein the detecting and/or decoding the transmission using an iterative operation comprises iteratively decoding the transmission.

4. The method as claimed in claim 1 wherein the iteration parameter is a count of iterations of the iterative operation.

5. The method as claimed in claim 1 wherein the iteration parameter is an error indicating parameter of the iterative operation which indicates a received error in the transmission.

6. The method as claimed in claim 5 wherein the error indicating parameter is a count of error indicating events in the iterative operation which indicate a received error in the transmission.

7. The method as claimed in claim 5 wherein the error indicating parameter is based on iteration messages which indicate an error.

8. The method as claimed in claim 5 wherein the error indicating parameter is based on failed parity check events, and optionally, the error indicating parameter is a count of failed parity check events.

9. The method as claimed in claim 5 wherein the error indicating parameter is based on a difference in the information passed between a first decoder and a second decoder decoding the transmission, and optionally, the error indicating parameter is a count of sign differences in the extrinsic information passed between the first decoder and second decoder decoding the transmission.

10. The method as claimed in claim 1 wherein the iteration parameter is a count, a count over a pre-determined amount of time, a count at one or more iterations or a cumulative count,
or wherein the method comprises detecting the transmission with a trellis detector.

11. (canceled)

12. The method as claimed in claim 1 wherein the transmission is non-orthogonal.

13. The method as claimed in claim 1 wherein the method further comprises changing the transmission system based on the determination of the transmission quality.

14. A determining apparatus configured to determine a transmission quality of an optical transmission,
the determining apparatus configured to receive information from a receiver comprising an optical detector and a decoder, wherein at least one of the optical detector and decoder are configured to use an iterative operation,
wherein the determining apparatus comprises:
a measurement unit configured to measure a value of one or more iteration parameter of the iterative operation, and
a calculation unit configured to calculate the transmission quality based on the value of the one or more iteration parameter.

15. The apparatus as claimed in claim 14 wherein the measurement unit is configured to measure a value of an iteration parameter from an iterative operation between the detector and decoder.

16. The apparatus as claimed in claim 14 wherein the measurement unit is configured to measure a value of an iteration parameter from an iterative operation of the decoder.

17. The apparatus as claimed in 14 wherein the iteration parameter is a count of iterations in the iterative operation.

18. The apparatus as claimed in 14 wherein the iteration parameter is an error indicating parameter of the iterative operation which indicates a received error in the transmission.

19. The apparatus as claimed in claim 18 wherein the error indicating parameter is based on iteration messages which indicate an error.

20. The apparatus as claimed in claim 18 wherein the error indicating parameter is based on failed parity check events, or, the error indicating parameter is based on a difference in the information passed between a first decoder and a second decoder configured to decode the transmission.

21. The apparatus as claimed in claim 14 wherein the iteration parameter is a count over a pre-determined amount of time, a count at one or more iterations or a cumulative count,
or wherein at least part of the determining apparatus is integral with the receiver comprising the detector and the decoder, wherein at least one of the detector and decoder are configured to use an iterative operation.

22. (canceled)
